(19) United States
(12) Patent Application Publication
(10) Pub. No.: US 2009/0290494 A1
(43) Pub. Date: Nov. 26, 2009

(54) SYSTEM AND METHOD FOR MOBILITY IN MULTIHOP NETWORKS

(75) Inventors: Saravanan Govindan, Singapore (SG); Pek Yew Tan, Singapore (SG)

Correspondence Address: Christensen O'Connor Johnson Kindness PLLC, 1420 Fifth Avenue, Suite 2800, Seattle, WA, 98101-2347, US

(73) Assignee: MATSUSHITA ELECTRIC INDUSTRIAL CO., LTD., Osaka (JP)

(21) Appl. No.: 12/097,688

(22) PCT Filed: Oct. 17, 2006
(86) PCT No.: PCT/JP2006/321004

§ 371 Date: Jun. 16, 2008

(51) Int. Cl. H04B 7/14; H04J 1/16

(52) U.S. Cl. 370/238; 370/315

(57) ABSTRACT

A network controller (NC) (105) that reduces the overhead exchanges for mobility events in a communications network is disclosed. Such a communications network is constituted by a wireless multihop communications network comprising a multihop chain (MH) (130) that wirelessly connects in series wireless communications entities (WCE) (110, 115) for relaying and the network controller as a first entity. Within the wireless multihop communications network a mobile node (MN) (125) wirelessly communicates with the wireless communications entity (115) located at the end of the multihop chain (130). In a communications network, the network controller (105) manages the multihop chain (130), and upon determining that the communications path has to be changed by a mobility event (ME) (141), it establishes a wireless communication between the mobile node (125) and a wireless communications entity (120) by expanding (132) the multihop chain (130).

### TECHNICAL FIELD

The present invention pertains to operations of communications networks and, more particularly, it relates to mobility operations of communications entities in multihop networks.

### BACKGROUND ART

Wireless technologies have diverse applications. They offer convenience and flexibility to communications applications. Increasingly, they are used to enable communications in mobile environments. Consequently communications can be conducted while communicating entities are non-stationary. Mobile communications enable any or all communicating entities to exchange communications while moving.

Large-scale wireless deployments are now focusing on mesh configurations. In such configurations, communications equipment units and mobile wireless terminals are interconnected in a mesh structure. Each network entity acts as both traffic source or destination and as traffic relaying point. Mesh network entities comprise a single or plurality of antennas or radios in order to perform the dual tasks of transmission/reception and relaying.

[Problems with Mesh]

1. Neighbour Discovery

Each mesh network entity is communicably coupled to a plurality of other mesh network entities. Consequently a mesh network entity comprises a plurality of neighbours, with which communications are exchanged. The presence of a plurality of neighbours leads to the availability of a plurality of communications paths between mesh network entities. This is a fundamental characteristic of mesh networks. The availability of a plurality of communications paths provides redundancy. However, it is also the cause for tremendous complexity and communications delays.

In the case of mobile communications, mesh networks require extensive overhead. When a mesh network entity moves from a first location to a second location, it must first discover a plurality of new neighbour mesh network entities. Consequently, the mobile mesh entity must conduct a plurality of discovery exchanges with each of its new neighbours. Furthermore, each of the mobile mesh entity's old neighbours must detect the mobility event and update their operations. So the management of a plurality of neighbours in a mesh network adversely affects operational efficiency through greater complexity and unfavourably affects communications performance through increased delays and reduced throughput.

2. Destination Path Discovery

The other major problem with mesh network's arises subsequent to neighbour discovery—path discovery. The plurality of new neighbour mesh network entities requires discovery of new communications paths to the intended destination entity. This discovery requires extensive overhead in the form of path discovery exchanges. In an example of the Ad Hoc On-Demand Distance Vector (AODV) mesh routing mechanism, a mobility event by a mesh network entity triggers a broadcast flood of AODV Route Request (RREQ) messages throughout the mesh network. The AODV RREQ messages serve to discover communications paths from the source mobile mesh network entity to its destination through the plurality of mesh neighbour entities and mesh communications paths. AODV requires reverse, paths to be established, for which AODV Route Response (RREP) messages are sent back to the initiating mesh network entity.

It is clear that the process of discovering new communications paths after a mobility event in a mesh network require substantial overhead in terms of volume of control traffic and amount of processing cycles. Such overhead adversely affects communications performance. In a first case, the discovery of new communications paths with the destination is time-consuming due to exchange of the numerous discovery exchanges and discovery of a plurality of communications paths. In a second case, the discovery of new communications paths increases the volume of control traffic in the mesh network, reducing available bandwidth for actual communications traffic. This is a critical factor for mesh networks are many of the communications links are wireless links, which have lower communications bandwidth than wired links. For example, IEEE 802.11 based wireless mesh networks have gross throughput capacity of 54 Mbps over each link as opposed to 1 Gbps or greater throughput capacities available with wired technologies such as Ethernet and optical fibers. The broadcast flood of AODV RREQ messages over bandwidth limited wireless links significantly reduces available bandwidth for data communications. So the discovery of a plurality of communications paths in a mesh network requires tremendous overhead and significantly reduces available bandwidth for communications.

3. Path Optimization

Another problem with mobility in mesh networks arises after a plurality of communications paths is discovered. The mobile mesh network entity must perform path optimization and path selection steps to select the best paths for communications. These steps require intensive computation power at the mesh network entity. In many cases, mobile mesh network entities are handheld devices such as phones, PDAs or laptops, which have limited processing power and limited battery life. Computing complex path optimization algorithms required in mesh networks is not ideal for such devices.

The problem of computing path optimizations is exacerbated by the number of times such computations are made. Mesh networks are characterized by regular mobility events, each of which, requires the steps of new neighbour discovery, destination path discovery and path optimization. As the number of these events increase, the amount of intensive overhead computations to be made also increases. This effectively reduces the processing cycles of mesh network entities and consequently, decreases communications performance.

Such problems of new neighbour discovery, destination path discovery and path optimization severely restricts the deployment of wireless communications networks capable of cost-effectively supporting mobile communications.

Prior-Art 1 illustrates a method for conducting route discovery through micro-mobility or macro-mobility means based on change of Internet Protocol (IP) addressess. According to the method, mobile wireless nodes discover a plurality of new routes after a mobility event. The discovery process may be based on the same IP address or different IP address. While this method seems logical, it ignores the complexity required for discovery a plurality of new routes in a bandwidth-limited wireless environment. Further, the computational requirements for computing optimal routes by power-constrained mobile wireless nodes are significant. So this method has limited practical scope in its current form.

Prior-Art 2 presents a method for dynamically allocating communications network resources in response to mobility events. The method involves separation of control signaling portion from data transmission portion of a communications session, with the aim of expediting resource allocations during mobility events. However, the method assumes a single signaling event is sufficient for a data transmission event in a wireless mesh network. The plurality of mesh network entities requires a plurality of signaling events for appropriate resource allocation. So by only separating control signaling from data transmission, the method does not address the problems of path discovery among a plurality of mesh neighbours in a mesh network.

Prior-Art 3 illustrates a method for opportunistic data transmission in a wireless mesh network. Mesh network entities monitor network activity and exchange connectivity information with each other. Transmissions are then made when connectivity is high, thereby reducing retransmissions. This method addresses the problem of retransmissions due to route uncertainty. However, in doing so, it introduces the problem of unbounded transmission latencies. Furthermore, the method requires each mesh network entity to incorporate opportunity-seeking processing capabilities, which increases its cost and complexity.

Prior-Art 4 presents a system in which a wireless communications network is configured in a tree structure of access points (APs). Customer Premise Equipments (CPEs) are then connected to “branch” APs, through which the “branch” paths are established to a gateway. This system deals with limited relay configurations for connectivity. When a CPE moves, this system requires the old “branch” path to be torn and requires a new “branch” path to be established. These significant overheads prevent seamless communications performance for mobile nodes.

Prior-Art 5 presents a method for computing cost of routes and using those costs to determine optimal routes in a mesh network. The method for calculating costs includes various routing and wireless metrics. This method assumes that the routing and wireless metrics are stable in order to calculate optimal routes. However, these metrics are dynamic due to the inherent nature of wireless communications. Consequently, adapting to changes in these conditions is highly complex. The method is not ideally suited for power-constrained mobile nodes.

The prior arts discussed insofar illustrate the lack of existing mechanisms to address the needs of mobility in wireless communications networks. In particular, these needs comprise simple, cost-effective mobility updates, minimal control overhead and quick establishment of communications sessions after mobility events.

[Prior-Art 1] U.S. Pat. No. 6,879,574, B2, “Mobile mesh ad-hoc networking,” June 2002.
[Prior-Art 2] U.S. Pat. No. 6,665,311 B2, “Method and apparatus for adaptive bandwidth reservation in wireless ad-hoc networks,” November 2001.
[Prior-Art 3] U.S. Pat. No. 6,965,568 B1, “Multi-hop packet radio networks,” May 2005
[Prior-Art 4] US 2003/018 5169 A1, “Wireless internet access system,” March 2002.
[Prior-Art 5] US 2004/025 2643 A1, “System and method to improve the network performance of a wireless communications network by finding an optimal route between a source and a destination,” June 2004.

### DISCLOSURE OF INVENTION

### Problems to be Solved by the Invention

In view of the above discussed problems, it is an objective of the present invention to provide systems and methods for managing mobility in wireless communications networks.

It is another objective of the invention to provide methods for reducing the overheard exchanges for mobility events in wireless communications networks.

It is an objective of the invention to provide methods for configuring a single or plurality of wireless communications entities in multihop chain configurations.

It is another objective of the invention to provide methods for adapting multihop chain configurations of wireless communications networks in response to mobility events.

It is another objective of the invention to provide methods for managing mobility events in localized areas of a wireless communications network.

### Means for Solving the Problem

The present invention addresses the problems relating to managing mobility in wireless communications networks comprising multihop chain configurations. In particular, the invention addresses the problems of large overhead exchanges arising from mobility events. The invention also addresses the problem of prolonged delays in establishing communications after mobility events.

In its broadest aspect, the present invention provides a system for managing network conditions in a communications network comprising, means for monitoring a single or plurality of network conditions; and means for representation of said network conditions over a single or plurality of communications entities; whereby, said representations of network conditions are adapted in response to changes in network conditions.

In a preferred form of the invention for managing network conditions, said representations are representative of network conditions of a first communications entity and a second communications entity. In another preferred, form of the invention, said representations are representative of network conditions of a first communications entity and a second communications entity; whereby, said representations are further representative of network conditions of a single or plurality of intermediate communications entities between said first and second communications entities. In a preferred form of the invention, said representations of network conditions comprise network distance, communications delay, communications traffic load between a first communications entity and a second communications entity.

In another preferred form of the invention, said representations are singularly representative of network conditions of a plurality of communications entities. In another aspect of the invention for managing network conditions in a communications network, a system is presented comprising; means for calculating effect of network conditions on communications performance; and means for adaptation of representations of said network conditions; whereby, said adaptation of representations are used to adjust communications resources.

In a preferred form of the invention, said communications resources are adjusted to improve communications throughput, to manage mobility, to reduce communications delay or to change network distance among communications entities.

In one aspect of the invention for managing network conditions, a system is presented comprising means for adaptation of representations of said network conditions; whereby, said adaptation comprises expansion or contraction of said representations.

In another aspect of the invention, a system is presented for selecting a communications network for receiving communications services comprising means for calculating adaptations of representations of network conditions of said communication network; whereby, said communications network is selected based on calculated adaptation of representations.

In yet another aspect of the invention, a system is presented for managing network conditions in a communications network comprising means for aggregating or disaggregating adaptations of a plurality of representations of network conditions.

### BRIEF DESCRIPTION OF DRAWINGS

FIG. 1 illustrates a communications network comprising network controller, wireless communications entities and mobile nodes within which the present invention operates;

FIG. 2 depicts a communications network exemplifying operations of the present invention;

FIG. 3 is illustrative of a communications network embodying operation of the present invention;

FIG. 4 is illustrative of a communications network exemplifying operations of the present invention;

FIG. 5 depicts operative steps of the invention;

FIG. 6 is illustrative of operations of the present invention within a plurality of communications networks;

FIG. 7 illustrates a sequence of operations in accordance with the invention;

FIG. 8 illustrates another sequence of operations in accordance with the invention;

FIG. 9 depicts system block diagram of an apparatus embodying the invention;

FIG. 10 is illustrative of message format of exchanges of the invention;

FIG. 11 is illustrative of the message format of exchanges of the invention in an embodiment for IEEE 802.16 communications networks;

FIG. 12 depicts sequence of operation of the present invention;

FIG. 13 illustrates flow chart of operations flow of the invention; and

FIG. 14 is illustrative of a communications network comprising a network control and a plurality of wireless communications entities operating in accordance with the present invention.

### BEST MODE FOR CARRYING OUT THE INVENTION

In the following description, for the purpose of explanation, specific numbers, times, structures and other parameters are set forth in order to provide a thorough understanding of the present invention. However, it will be apparent to those skilled in the art that the present invention may be practiced without these specific details.

### Embodiment 1

### Network Spring

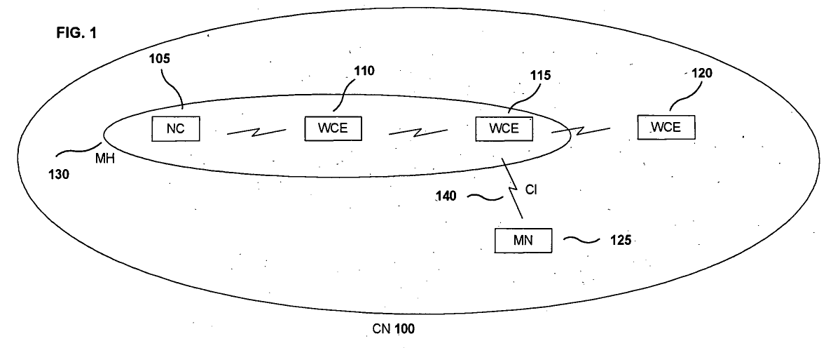

With reference to FIG. 1, a communications network (CN) (100) in accordance with the current invention is illustrated. CN (100) comprises a network controller (NC) (105), a single or plurality of wireless communications entities (WCE) (110), (115) and (120) and a single or plurality of Mobile Nodes (MN), such as MN (125).

NC (105) is representative of a controller entity capable of coordinating network resources, provisioning and configuring WCEs and MNs, such as WCE (110), WCE (115), WCE (120) and MN (12.5), and coordinating communications flows among them. NC (105) may be an access controller, Mobile Multihop Relay (MMR) base station or other type of base station. WCEs are representative of communications devices such as wireless access points or relay stations, capable of transmitting, receiving and relaying communications traffic. MN (125) is representative of a mobile devices operating on a single or plurality of wireless communications technologies such as Bluetooth, IEEE 802.11, IEEE 802.16, GPRS, WCDMA or CDMA2000.

In accordance with the invention for mobility in wireless multihop communications networks, a single or plurality of WCEs of CN (100) are organized in a multihop configuration, heretofore referred to as multihop chain. Multihop chain (MH) (130) is a logical configuration comprising NC (105), WCE (110) and WCE (115). Communications traffic of a single or plurality of MNs associated with WCEs of MH (130), such as communications traffic of MN (125) associated with WCE (115), is exchanged with NC (105) through MH (130). Consequently, NC (105) communicates with WCEs or MNs associated with WCEs over intermediate WCEs. As an example, in CN (100) of FIG. 1, communications between NC (105) and MN (125) are exchanged via intermediate WCEs of MH (130) comprising WCE (110) and WCE (115). According to the invention, multihop chains, such as MH (130), are characterized by a single communications path between NC (105) and any constituting WCE (110), WCE (115) or MN (125) of the multihop chain.

WCEs and MNs constituting multihop chains are communicably coupled with NC, other WCEs and MNs of multihop chains by means of wireless interfaces such as Bluetooth, IEEE 802.11, IEEE 802.16, GPRS, WCDMA and CDMA2000.

In accordance with the current invention, each multihop chain of a communications network is characterized by a single or plurality of Network-Springs (Net-Spring). Net-Springs are representative of network conditions occurring between end-nodes and among intermediate nodes. In particular, Net-Springs are representative of network conditions occurring within a multihop chain MH (130). So Net-Springs represent network conditions over a plurality of communications entities constituting a multihop chain.

A Net-Spring of a multihop chain comprises a Net-Spring identifier, multihop chain identifier, value of Net-Spring and adaptation metric. The Net-Spring identifier identifies the Net-Spring. The multihop chain identifier is indicative of the multihop chain that is characterized by the Net-Spring. The identifiers may be represented by a single or plurality of bits. They may also be represented by a single or plurality of characters. The value of Net-Spring indicates the network conditions of the multihop chain characterized by the Net-Spring. The adaptation metric indicates the prevailing type of adaptation of the Net-Spring. The adaptation metric may have values comprising expansion, contraction and no-change.

The dynamic nature of network conditions of a multihop chain is adapted to by the Net-Spring representing the multihop chain. So as network conditions change within a multihop chain, MH (130), its Net-Springs also adapt to represent the change. A Net-Spring adapts by expanding or contracting in accordance with the change exhibited by the network condition of which the Net-Spring is representative of. Reactive operations are then conducted based on the adapted Net-Spring in accordance with the present invention.

In CN (100), a Net-Spring is representative of the path length of multihop chain MH (130), over which MN (125) and NC (105) exchange communications across intermediate WCEs constituting MH (130). Such a Net-Spring is dynamic due to mobility conditions of MN (125) within CN (100).

Net-Springs dealing specifically with path length of multihop chains are hereinfore referred to as Hop-Springs. Hop-Spring is representative of the number of hops required to exchange communications between communications entities of a multihop chain. In one aspect of the invention, path length is measured in number of hops. In other aspects of the present invention, path length of a multihop chain may be measured in a single or plurality of metrics, such metrics comprising time delay and physical distance.

A Hop-Spring of a multihop chain comprises a Hop-Spring identifier, multihop chain identifier, value of Hop-Spring and adaptation metric. The Hop-Spring identifier identifies the Hop-Spring. The multihop chain identifier is indicative of the multihop chain that is characterized by the Hop-Spring. The identifiers may be represented by a single or plurality of bits. They may also be represented by a single or plurality of characters. The value of Hop-Spring indicates the network distance between end-nodes of the multihop chain characterized by the Hop-Spring. The network distance may be measured in metrics such as number of hops, time delay and physical distance between the end-nodes. The adaptation metric indicates the prevailing type of adaptation of the Hop-Spring. The adaptation metric may have values comprising expansion, contraction and no-change. In another aspect of the invention, the adaptation metric may have fractional or partial values.

In CN (100), Hop-Spring is representative of the number of hops of MH (130), over which communications are exchanged between MN (125) and NC (105). The hops of MH (130) comprise a single or plurality of intermediate WCEs such as WCE (110) and WCE (115). As MN (125) moves from a first WCE (115) to any second WCE, the Hop-Spring of MH (130) adapts by contracting or expanding to reflect the new path length of MH (130). So Hop-Spring for MH (130) changes from initial “2” hops between WCE (115) and NC (105), to subsequent number hops based on the extent of the mobility event. In one aspect of the invention, Hop-Spring is representative of the path length of the multihop chain, such as MH (130). In another aspect of the invention, Hop-Spring is representative of the path length of the multihop chain, such as MH (130), and the hop of mobile nodes, such as MN (125).

In accordance with the present invention, a multihop chain of a communications network is adaptive on the basis of the Hop-Spring representative of the multihop chain. In CN (100) of FIG. 1, MH (130) is adaptive on the basis of the Hop-Spring representative of the path length of MH (130).

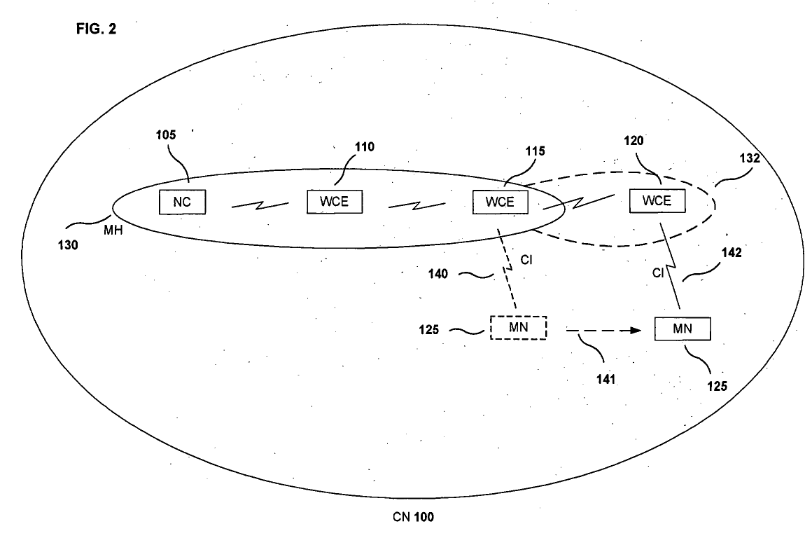

FIG. 2 is illustrative of a multihop chain adapting in response to changes in its Hop-Spring. In FIG. 2, multihop chain MH (130) adapts by means of expansion. MH (130) initially comprises WCE (110) and WCE (115). MN (125) is communicably coupled with WCE (115) by Communications Interface (CI) (140). MN (125) exchanges communications with NC (105) across CI (140) and across intermediate WCEs of MH (130). Hop-Spring of MH (130) is initially “2” hops.

In a subsequent step, Mobility Event (ME) (141) results in MN (125) moving from a first location to a second location. In the second location, MN (125) establishes communications coupling with WCE (120) over CI (142). ME (141) also results in an increase in the path length between MN (125) and NC (105). Hop-Spring of MH (130) expands to reflect the new path length. Hop-Spring of MH (130) expands from initial “2” hops to a subsequent “3” hops.

In accordance with the present invention for managing mobility, NH (130) adapts on the basis of its Hop-Spring. MH (130) expands to include WCE (120) by the multihop expansion (132). The expanded NH (130) of FIG. 2 then comprises NC (105), WCE (110), WCE (115) and WCE (120). The path length of MH (130) comprising multihop expansion (132) reflects the change in its Hop-Spring. The path length of NH (130) becomes “3” hops.

This advantage of the present invention is highlighted in this illustration. Mobility events in wireless communications networks are accommodated by adapting to changes in the Hop-Spring representative of the mobility event. In FIG. 2, Hop-Spring of NH (130) expands to accommodate new path length. Subsequently, NH (130) adapts through multihop expansion (132) to include a further WCE (120). The illustration highlights the MH (130) adapts locally through (132) at the end of the multihop chain. The invention therefore reduces the overhead and delay.

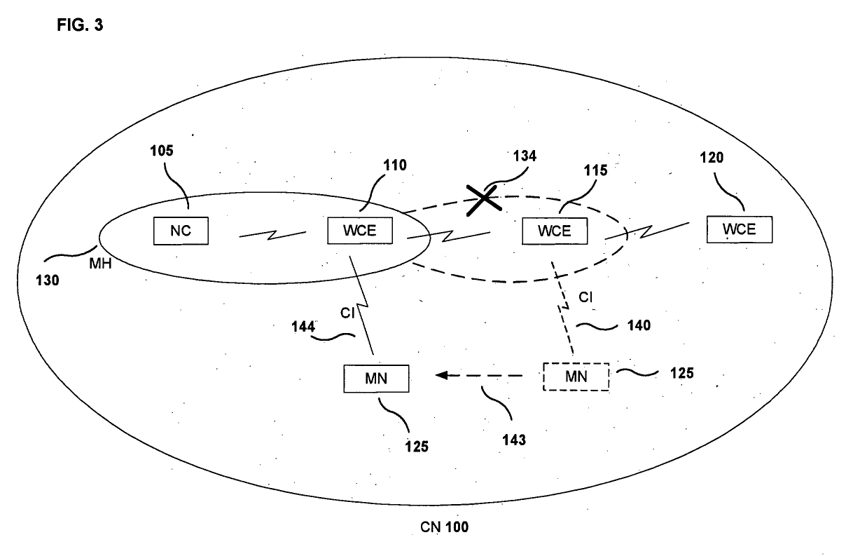

FIG. 3 is illustrative of a multihop chain adapting in response to changes in its Hop-Spring. In FIG. 3, multihop chain NH (130) adapts by means of contraction. NH (130) initially comprises WCE (110) and WCE (115). MN (125) is communicably coupled with WCE (115) by CI (140). MN (125) exchanges communications with NC (105) across CI (140) and across intermediate WCEs of NH (130). Hop-Spring of NH (130) is initially “2” hops.

In a subsequent step, Mobility Event ME (143) results in MN (125) moving from a first location to a second location. In the second location, MN (125) establishes communications coupling with WCE (110) over CI (144). ME (143) also results in a decrease in the path length between MN (125) and NC (105). Hop-Spring of MH (130) contracts to reflect the new path length. Hop-Spring of MH (130) contracts from initial “2” hops to a subsequent “1” hop.

In accordance with the present invention for managing mobility, MH (130) adapts on the basis of its Hop Spring. MH (130) contracts to exclude WCE (115) by the multihop contraction (134). The contracted MH (130) of FIG. 3 then comprises NC (105) and WCE (110). The path length of MH (130) comprising multihop contraction (134) reflects the change in its Hop-Spring. The path length of MH (130) becomes “1” hop.

The illustrations of FIG. 2 and FIG. 3 highlight the advantage of the invention for managing various mobility events. In accordance with the invention, Hop-Springs adapt to changes in path length. Multihop chains then adapt based in accordance with their Hop-Springs. Multihop chains adapt locally by expansion or contraction thereby reducing overhead and delay for communications in mobility events.

### Embodiment 2

### Alternative MH-Chain, Net-Spring Type

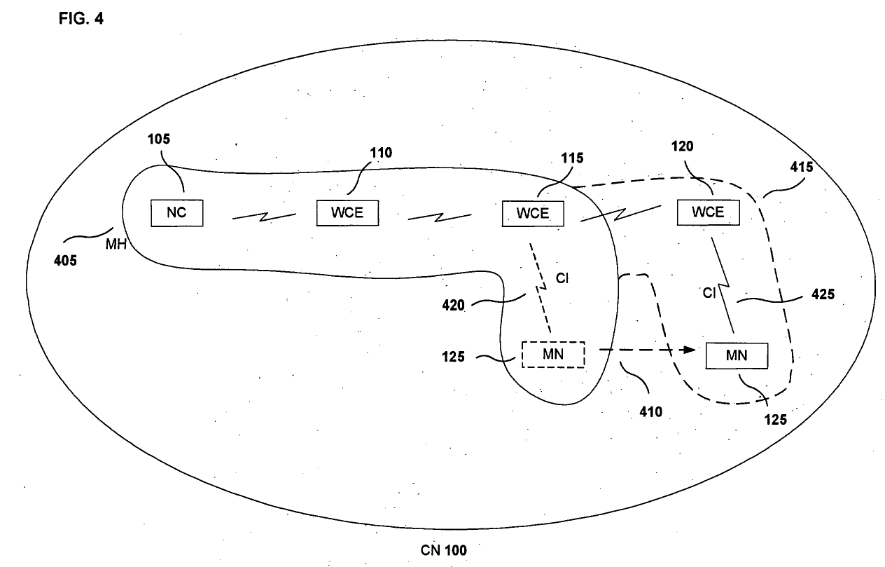

In one aspect of the invention, multihop chains are configured to comprise mobile nodes in addition to WCEs. FIG. 4 is illustrative of CN (100) comprising such a multihop chain.

In CN (100) of FIG. 4, multihop chain MH (405) comprises mobile node MN (125), NC (105), WCE (110) and WCE (115). Communications entities constituting MH (405) are communicably coupled by means of communications interfaces operating on a single or plurality of communications technologies comprising Bluetooth, IEEE 802.11, IEEE 802.16, GPRS, WCDMA or CDMA2000. MN (125) is communicably coupled to WCE (115) through a communications interface CI (410).

In accordance with the present invention for managing mobility, MH (405) is associated with a Hop-Spring representative of the path length of MH (405). In initial state, path length and Hop-Spring of MH (405) is “3” hops. The Hop-Spring adapts on the basis of mobility events in CN (100).

In a subsequent step, Mobility Event ME (410) results in MN (125) moving from a first location to a second location. In the second location, MN (125) establishes communications coupling with WCE (120) over CI (415). ME (410) also results in an increase in the path length between MN (125) and NC (105). Hop-Spring of MH (405) expands to reflect the new path length. Hop-Spring of MH (405) expands from initial “3” hops to a subsequent “4” hops.

In accordance with the present invention for managing mobility, MH (405) adapts on the basis of its Hop-Spring. MH (405) expands to include WCE (120) by the multihop expansion (415). The expanded MH (405) of FIG. 4 then comprises NC (105), WCE (110), WCE (115), WCE (120) and MN (125). The path length of MH (405) comprising multihop expansion (415) reflects the change in its Hop-Spring. The path length of MH (405) becomes “4” hops.

The illustration of FIG. 4 highlights one aspect of the invention involving multihop chains comprising mobile nodes. The invention is therefore shown to be applicable to multihop chains of varying designs. The illustration of FIG. 4 also presents the advantage of Hop-Spring. Hop-Spring enables locality of updates for managing mobility. Consequently, multihop chains adapt by expanding or contracting at the point of mobility event. The present invention has the performance advantages of reduced overhead and delay.

### Embodiment 3

### Sequence of Net-Spring

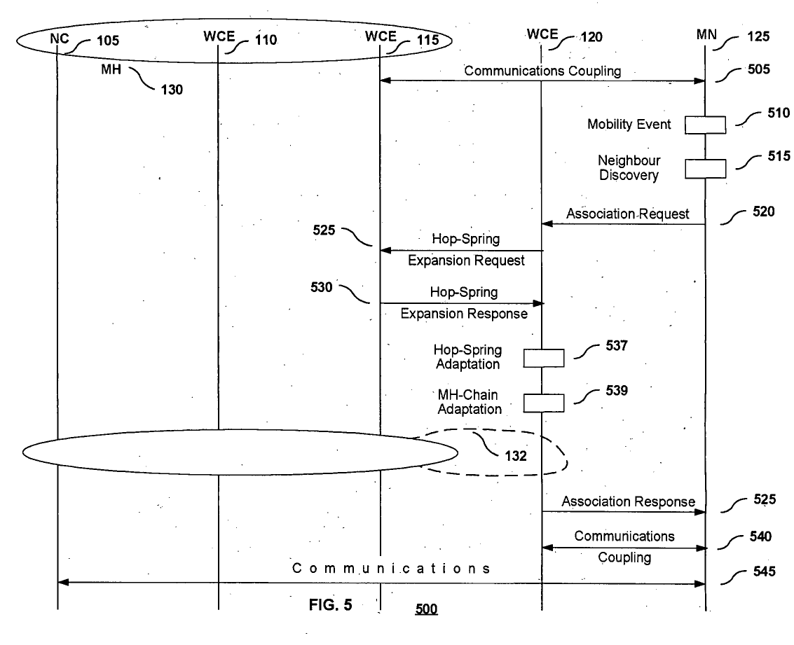

The Hop-Spring method of multihop chain adaptation is performed at the location of mobility event. FIG. 5 is illustrative of a sequence of adaptation operations (500) among NC (105), WCE (110), WCE (115), WCE (120) and MN (125) of CN (100).

The operative steps of (500) are performed in accordance with a single or plurality of communications protocols such as those comprising the set of Bluetooth, IEEE 802.11, IEEE 802.16, CAPWAP, GPRS, WCDMA and CDMA2000. In one aspect of the invention of Net-Spring, operative messages of (500) are exchanged as control messages of said communications protocols. In other aspects of the present invention, operative messages of (500) are exchanged as combinations of control messages and payload of data messages of said communications protocols.

In the current embodiment, NC (105), WCE (110) and WCE (115) of CN (100) constitute multihop chain MH (130) In an initial communications coupling step (505), MN (125) is communicably coupled with WCE (115). In step (505), MN (125) exchanges communications information with NC (105) through intermediate WCEs (110) and (115) constituting MN (130) MN (125) exchanges data and control communications with WCE (115) and NC (105).

A Mobility Event step (510) causes MN (125) to move from an initial location to a second location. In one aspect of the invention, Mobility Event step (510) occurs as a result of physical displacement of MN (125) from a first location to a second location. This may be due to a traveling user of MN (125). In another aspect of the invention, Mobility Event step (510) occurs as a result of a logical displacement from a first communications point to a second communications point. This may be due to a user of MN (125) switching from a local area communications network to a wide area communications network.

In a second location, MN (125) performs a Neighbor Discovery step (515) to determine a communications entity to conduct direct communications. The Neighbor Discovery step (515) comprises transmission of beacon or probe request messages. In step (515), MN (125) discovers WCE (120) to be a neighbor communications entity.

After discovery of WCE (120), MN (125) sends an Association Request to WCE (120) in a step (520). The Association Request is an initial step in exchanging communications with WCE (120). Association Request comprises information regarding previous communications state of MN (125). In particular, this information comprises identification of multihop chain MH (130), through which MN (125) conducted communications with NC (105), previous Hop-Spring value of MH (130), “2” hops and previous neighbour WCE (115) of MN (125). The step (520) provides WCE (120) information for establishing communications coupling with MN (125).

Upon receiving Association Request and the comprising information in a step (520), WCE (120) commences membership in MH (130). In a step (530), WCE (120) sends a Hop-Spring Expansion Request to the previous neighbour WCE (115) of MN (125). The step (530) indicates expansion of Hop-Spring of MH (130). The Hop-Spring Expansion Request seeks inclusion of WCE (120) in MH (130).

In an acknowledgement to step (525), WCE (115) of MH (130) responds with a Hop-Spring Expansion Response in a step (530). The Hop-Spring Expansion Response confirms the Mobility Event (510) and initiates inclusion of WCE (120) in MH (130). Hop-Spring Expansion Response (530) may be either positive or negative depending on prevailing conditions and configurations. In an example, Hop-Spring Expansion Response (530) is negative if credentials of WCE (120) are unauthorized. In another example, Hop-Spring Expansion Response (530) is positive for all WCEs.

A subsequent step (537) involves adaptation of the Hop-Spring of MH (130). The adaptation step (537) comprises operation options such as, expansion, contraction and no-change. The no-change option is used upon a negative Hop-Spring Expansion Response (530).

In the case of positive Hop-Spring Expansion Response, Hop-Spring of MH (130) adapts by expanding in a step (537). Hop-Spring of MH (130) adapts by expanding in a step (537). The Hop-Spring values adapts from initial “2” hops to “3” hops in step (537). Multihop chain MH (130) adapts in response to its Hop-Spring. In a step (539), MH (130) expands to include WCE (120). MH (130) subsequently comprises multihop expansion (132) as a result of MH-Chain Adaptation step (539). The path length of MH (130) increases to “3” hops.

In one aspect of the invention, MN (125) comprises MH (130). In this case, Hop-Spring of MH (130) expands from an initial “3” hops to subsequent “4” hops consequent to Hop-Spring Adaptation step (537) and MH-Chain Adaptation step (539).

In a step (525), WCE (120) sends an Association Response to MN (125). The Association Response comprises the results of the Association Request of step (520) and communications parameters. The communications parameters of step (525) comprise transmit power, operating schedules, channel access parameters and statistics.

Upon receiving communications parameters, MN (125) is communicably coupled to WCE (120) of expanded MH (130) in a step (540). MN (125) then commences communications with NC (105) through WCE (120) in a step (545). NC (105) is informed of the expansion of Hop-Spring of MH (130) through communications with MN (125).

The embodiment highlights the operative steps of the invention for Hop-Spring method of mobility management. Operations sequence (500) illustrates local updates and adaptations are made to MH (130) to result in reduced overhead and faster communications coupling for MN (125) after a mobility event. The result of the Hop-Spring method is higher communications performance for communications between NC (105) and MN (125).

### Embodiment 4

### Delay-Spring & Load-Spring

In one embodiment of the present invention, the Net-Spring method is applicable for further network conditions of multihop chains.

In one aspect of the embodiment for further network conditions, Net-Spring is representative of delay conditions in a multihop chain of a communications network. Such a Net-Spring represents the communications delay in exchanging communications in a multihop chain. In this aspect of the embodiment, a Net-Spring of CN (100) is representative of the communications delay of multihop chain MH (130), over which MN (125) and NC (10.5) exchange communications across intermediate WCEs constituting MH (130). Such a Net-Spring is dynamic due to the nature of wireless communications links, mobility conditions of intermediate. WCEs and variations in traffic conditions.

Net-Springs dealing specifically with communications delays of multihop chains are hereinfore referred to as Delay-Springs. Delay-Spring is representative of the delay encountered by a communications unit exchanged between communications entities of a multihop chain. In one aspect of the invention, delay is measured as elapsed time between transmission of a communications unit at a first multihop chain entity and reception of the communications unit at a second multihop chain entity. In other aspects of the present invention, Delay-Spring is representative of round-trip delay between a first and second multihop chain entity.

A Delay-Spring of a multihop chain comprises a Delay-Spring identifier, multihop chain identifier, value of Delay-Spring and adaptation metric. The Delay-Spring identifier identifies the Delay-Spring. The multihop chain identifier is indicative of the multihop chain that is characterized by the Delay-Spring. The identifiers may be represented by a single or plurality of bits. They may also be represented by a single or plurality of characters. The value of Delay-Spring indicates the communications delay between end-nodes of the multihop chain characterized by the Delay-Spring. The communications delay may be measured in metrics such as elapsed time between a communications transmission and a corresponding communications reception between the end-nodes. The adaptation metric indicates the prevailing type of adaptation of the Delay-Spring. The adaptation metric may have values comprising expansion, contraction and no-change. The adaptation metric may also have fractional or partial values.

In CN (100) of FIG. 1, MH (130) is characterized by a Delay-Spring. The Delay-Spring adapts to network conditions within the multihop chain. In an exemplification, Delay-Spring of MH (130) expands when interference increases over communications channel between WCE (115) and WCE (110). As a result of Delay-Spring expansion, MH (130) adapts in accordance with the present invention. MH (130) adapts by increasing transmission or scheduling priority for communications exchanged among constituting entities. So communications exchanges from MN (125) are assigned higher transmission or scheduling priority to accommodate increased delay conditions.

In another exemplification, Delay-Spring of MH (130) contracts when interference decreases over a communications channel of the multihop chain. As a result of Delay-Spring contraction, MH (130) adapts in accordance with the present invention. MH (130) adapts by increasing the number of communications sessions exchanged in the multihop chain.

The Delay-Spring method of the present invention highlights the advantage of managing interference conditions in a communications network. MH (130) adapts by changing a single or plurality of network parameters, said parameters comprising transmission priority, number of communications sessions to be admitted and communications schedules.

In another aspect of the embodiment, Net-Spring is representative of traffic load conditions in MH (130) between and among MN (125), NC (105) and intermediate constituting WCEs. Such a Net-Spring represents the communications load exchanged in a multihop chain. In this aspect of the embodiment, a Net-Spring of CN (100) is representative of the communications load over multihop chain MH (130) and its constituting intermediate WCEs. Such a Net-Spring is dynamic due to the communications requirements of communicating entities of MH (130). The Net-Spring is adaptive to traffic conditions arising throughout MH (130).

Net-Springs dealing specifically with communications load of multihop chains are hereinfore referred to as Load-Springs. Load-Spring is representative of the communications load exchanged between communications entities of a multihop chain. In one aspect of the invention, communications load is measured as the number of communications units exchanged in a multihop chain.

A Load-Spring of a multihop chain comprises a Load-Spring identifier, multihop chain identifier, value of Load-Spring and adaptation metric. The Load-Spring identifier identifies the Load-Spring. The multihop chain identifier is indicative of the multihop chain that is characterized by the Load-Spring. The identifiers may be represented by a single or plurality of bits. They may also be represented by a single or plurality of characters. The value of Load-Spring indicates the communications traffic load exchanged between end-nodes of the multihop chain characterized by the Load-Spring. The communications traffic load may be measured by a single or plurality of metrics such as the number of bytes exchanged, number of packets exchanged and number of communications sessions between the end-nodes. The adaptation metric indicates the prevailing type of adaptation of the Load-Spring. The adaptation metric may have values comprising expansion, contraction and no-change. The adaptation metric may also have fractional or partial values.

In CN (100) of FIG. 1, MH (130) is characterized by a Load-Spring. The Load-Spring adapts to network conditions within the multihop chain. In an exemplification, Load-Spring of MH-(130) expands when MN (125) increases its transmission to NC (105) over the multihop chain. As a result of Load-Spring expansion, MH (130) adapts in accordance with the present invention. MH (130) adapts by reducing the number of communications sessions exchanged in the multihop chain.

In another exemplification, Load-Spring of MH (130) contracts when MN (125) decreases its transmission to NC (105) over the multi hop chain. As a result of Load-Spring contraction, MH (130) adapts in accordance with the present invention. MH (130) adapts by increasing the number of communications sessions exchanged in the multihop chain.

The Load-Spring method of the present invention highlights the advantage of managing traffic conditions in a communications network. MH (130) adapts by changing a single or plurality of network parameters, said parameters comprising number of communications sessions to be admitted and communications schedules.

This embodiment illustrates the benefit of the Net-Spring method. Delay-Spring and Load-Spring aspects of the invention enhance communications performance of a multihop chain. They serve to adapt communications parameters to reduce delays and accommodate traffic load. The Net-Spring method illustrates the efficient characterization of network conditions between a first and second communications entity that accounts for intermediate communications entities.

### Embodiment 4a

### Generic Network Spring Adaptation

The current invention comprises Network Springs (Net-Springs). Net-Springs are representative of a single or plurality of network conditions occurring between end-nodes and among intermediate nodes. In accordance with the present invention, Net-Springs adapt in response to network conditions to enhance communications performance comprising mobility and QoS.

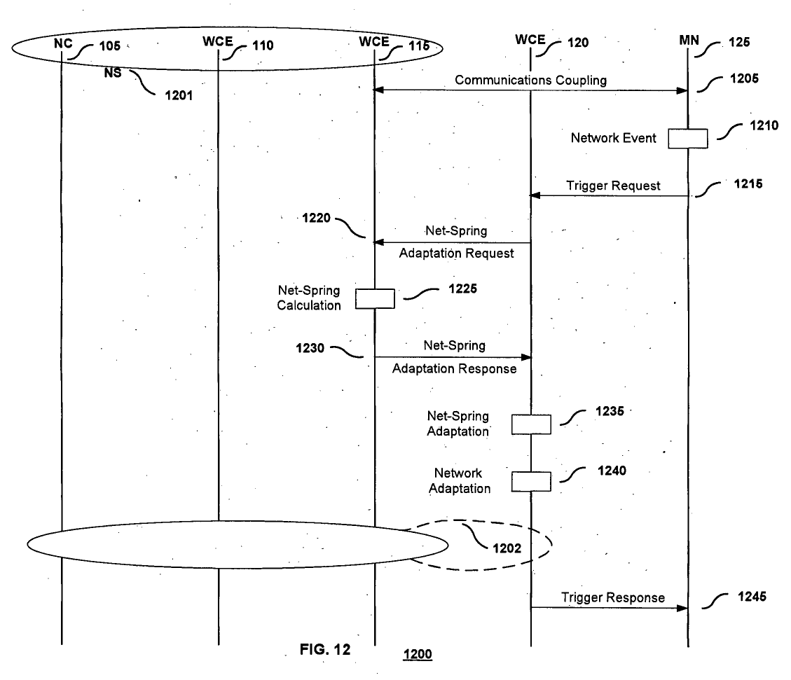

Net-Springs may be representative of the number of hops between end-nodes, the delay between end-nodes or the traffic load between end-nodes. The general adaptation method for Net-Springs representative of various network conditions is illustrated in by operations sequence (1200) of FIG. 12.

In an initial communications coupling step (1205), MN (125) is communicably coupled with WCE (115). In step (1205), MN (125) exchanges communications information with NC (105) through intermediate WCEs (110) and (115) constituting MN (130). MN (125) exchanges data and control communications with WCE (115) and NC (105).

Net-Spring (NS) (1201) is representative of network conditions between end-nodes WCE (115) and NC (105). In one aspect of the embodiment, MN (125) and NC (105) are considered end-nodes. In this aspect, Net-Spring NS (1201) is representative of network conditions between MN (125) and NC (105).

The network conditions represented by Net-Spring NS (1201) comprise number of hops between WCE (115) and NC (105), delay between the end-nodes and traffic between the end-nodes. In accordance with the invention, a single Net-Spring NS (1201) is representative of a network condition between end-nodes WCE (115) and NC (105) and also representative of the network condition of the intermediate path comprising WCE (110). For example, Hop-Spring is a variant of Net-Spring NS (1201), which is singularly representative of the network distance between the end-nodes WCE (115) and NC (105). The availability of a single representative metric for network distance between end-nodes enhances mobility performance by reducing communications signaling and decreasing handover delays.

The Network Event step (1210) is illustrative of a trigger for the present invention of adapting Net-Springs, such as NS (1201). Network Event (1210) comprises mobility, change in offered communications traffic load and change in contention levels of a wireless channel. The step (1210) triggers subsequent adaptation operations of the present invention. In one aspect of the embodiment, there may be a plurality of Network Event steps (1210) corresponding to a plurality of network conditions. Each of the network conditions may have changed in different manners. For example, MN (125) may have moved towards a further WCE, thereby increasing its network distance from NC (105). At the same time MN (125) may have reduced its offered communications traffic load to the network. The changes in network conditions of this example affect an increase in a corresponding Hop-Spring and affect a decrease in a corresponding Load-Spring. The operations of the present invention are applicable to distinct changes in network conditions simultaneously affecting a plurality of Net-Springs.

In response to a Network Event step (1210), MN (125) sends a Trigger Request to WCE (120) in a step (1215) Trigger Request step (1215), comprises Association Request, Connection Request or other requests in the cases changes in network conditions relating to Hop-Spring, Load-Spring or Delay-Spring. The type of trigger is specific to the type of Network Event. In one aspect of the invention, a Network Event step (1210) may result in a plurality of Trigger Requests (1215) corresponding to a plurality of variants of Net-Springs.

Upon receiving a single or plurality of Trigger Requests (1215), WCE (120) requests for corresponding adaptations of the Net-Springs affected by the changes in network conditions represented by said Trigger Requests. WCE (120) performs a single or plurality of Net-Spring Adaptation Request steps (1220) with the WCE (115) end-node of the corresponding Net-Springs. In one aspect of the invention, the WCE receiving the Trigger Request (1215) is the same WCE receiving and processing the Net-Spring Adaptation Request (1220). This aspect is applicable in cases where there is no change in the WCE in communications with MN (125). The case arises as a result of changes in network conditions related to delay or communications traffic-load.

In a step (1225), WCE (115) performs a Net-Spring Calculation step. The step comprises evaluation of the degree of change in network conditions such as network distance, delay or communications traffic load. The Net-Spring Calculation step (1225) also determines how Net-Springs corresponding to the network conditions are to be adapted. The result of the step (1225) may be expansion, contraction or no-change in the corresponding Net-Spring. The step (1225) results in an expansion when a Net-Spring is required to be expanded to accommodate the change in network conditions. For example, if MN (125) moves from WCE (115) to WCE (120), the network distance between MN (125) and NC (105) increases. This network condition requires the corresponding Hop-Spring to be expanded. In another example, if MN (125) decreases its transmission rate, the traffic communications load offered to NC (105) decreases. This network condition requires the corresponding Load-Spring to be contracted. In yet another example, if MN (125) moves from WCE (115) to WCE (120), the wireless communications channel changes. However, the interference condition of the communications channel may remain the same. This network conditions requires no-change in the corresponding Delay-Spring between WCE (115) and NC (105).

The result of the Net-Spring Calculation step (125) is notified to WCE (120) in a Net-Spring Adaptation Response step (1230). The step (1230) comprises information on the corresponding Net-Spring and degree of adaptation required. The step (1230) also comprises exchange of adaptation parameters such as hop-count, delay target and communications traffic load limit.

A subsequent step (1235) involves adaptation of the Net-Spring NS (1201). The Net-Spring Adaptation step (1235) comprises operation options such as, expansion, contraction and no-change. The no-change option is used upon a negative Net-Spring Adaptation Response (1230).

In a Net-Spring Adaptation step (1235) a single or plurality of corresponding Net-Springs are adapted in accordance with the Net-Spring Adaptation Response. So a single or plurality of Hop-Springs, Load-Springs and Delay-Springs may be expanded, contracted or left without change. In accordance with the present invention, the adaptation of a first Net-Spring may be distinct from the adaptation of a second Net-Spring. Such diverging adaptation steps may occur simultaneously.

In a step (1240), Network Adaptation event occurs. In this step, network elements related to the Net-Spring are adapted. In the case of Hop-Spring, corresponding multihop-chains are adapted.

The adaptation of Net-Spring NS (1201) is illustrated by (1202). Adaptation (1202) is in correspondence to the Net-Spring Adaptation step (1235).

After the adaptation of Net-Spring NS (1201), WCE (120) responds to Trigger Request (1215) with a Trigger Response (1245). The step (1245) is completion step of the adaptation method for a single or plurality of Net-Springs and variants.

This embodiment highlights the generic operation steps for the present invention for Net-Spring variants such as Hop-Spring, Load-Spring and Delay-Spring. The embodiment illustrates that a single or plurality of Net-Springs and variants are adapted in response to network conditions. It is also illustrated that the invention accommodates Net-Spring adaptations that may be simultaneously divergent. The advantage of the invention is that a Net-Spring adapts independently or in synthesis with other Net-Springs in response to a single or plurality of network conditions. The present invention therefore allows flexibility in accommodating network conditions and in enhancing communications performance.

### Embodiment 5

### Network Selection Application

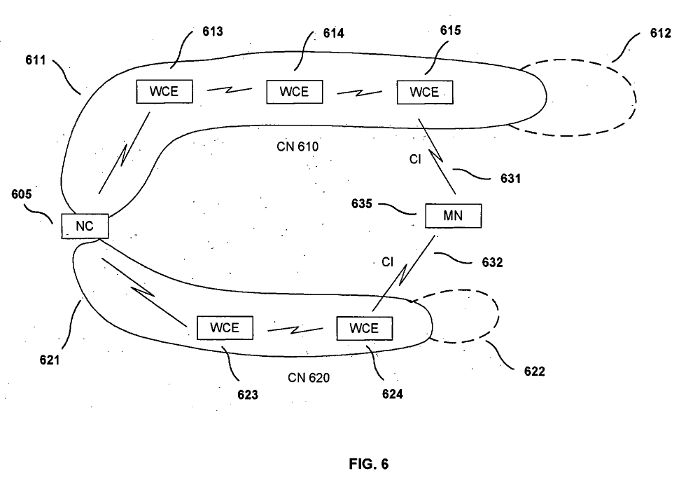

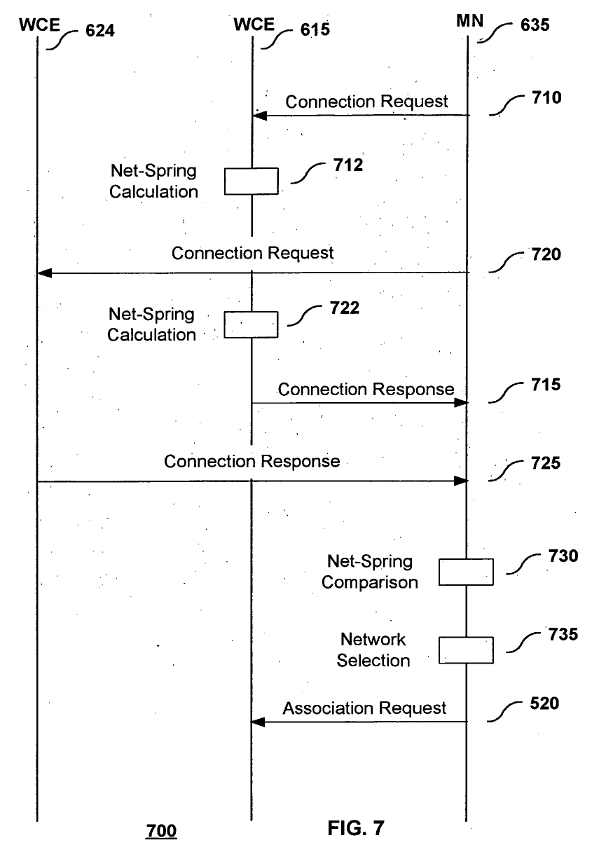

This embodiment illustrates an application of the Net-Spring method for network selection. Industry trends indicate the availability of a plurality of communications with a plurality of characteristics. These characteristics comprise price, delay, and traffic load. The availability of choice introduces a problem for selection. The Net-Spring method for alleviating this problem is presented with reference to communications networks of FIG. 6 and operation sequence (700) of FIG. 7.

FIG. 6 presents two communications networks CN (610) and CN (620). CN (610) and CN (620) provide communications with NC (605). The two communications networks are of distinct characteristics. In an example, CN (610) is operative on IEEE 802.16 and CN (610) is operative on WCDMA.

Multihop chain MH (611) of CN (610) comprises WCE (613), WCE (614) and WCE (615). Multihop chain MH (621) of CN (620) comprises WCE (623) and WCE (624). In accordance with the above example, WCEs (613), (614) and (615) are communicably coupled by means of IEEE 802.16 communications interfaces. WCE (613) is in turn communicably coupled with NC (605) by means of an IEEE 802.16 communications interface. Also in accordance with the example, WCEs (623) and (624) are communicably coupled by means of WCDMA communications interfaces. WCE (623) is in turn communicably coupled with NC (605) by means of a WCDMA communications interface.

MH (611) and MH (621) are characterized by distinct Delay-Springs. In an exemplification, Delay-Spring of MH (611) is longer than Delay-Spring of MH (621). Load-Spring of MH (611) is greater than Load-Spring of MH (621).

When a mobile node MN (635) initially commences operation, it must select from CN (610) and CN (620), through which to exchange communications with NC (605). The selection process determines cost and performance of communications. Consequently, the selection process is important for MN (635) and the communications networks CN (610) and CN (620).

In a step (710), MN (635) sends a Connection Request to WCE (615) of MH (611) in CN (610). In a step (715), MN (635) sends a Connection Request to WCE (624) of MH (621) in CN (620). The Connection Requests comprise information on the communications requirements of MN (635), such as delay bounds, throughput, cost and time duration. Connection Request steps (710) and (720) are exchanged through corresponding communications protocols such as Bluetooth, IEEE 802.11, IEEE 802.16, CAPWAP, GPRS, WCDMA or CDMA2000.

Upon receiving the Connection Request from MN (635), WCE (615) and WCE (624) determine the effect of admitting MN (635) in their respective CN (610) and CN (620). The step (712) at WCE (615) and step (722) at WCE (624) are Net-Spring calculation steps. The steps comprise calculation of the adaptation of Net-Springs of the multihop chains. In the current embodiment, the steps (712) and (722) comprise calculation of adaptation of Delay-Springs and Load-Springs of multihop chains MH (611) and MH (621), respectively.

In exemplification of the Net-Spring calculation steps (712) and (722), if MN (635) expects to transmit large data files, the Load-Springs of multihop chains will increase by a large factor. In another example, if MN (635) expects to transmit streaming information, high delays will not be tolerated. Correspondingly, WCE (615) and WCE (624) determine the adaptation of respective Delay-Springs and Load-Springs.

The determined Delay-Spring and Load-Spring values are then informed to MN (635) in Connection Response steps (715) and (725) by WCE (615) and WCE (625), respectively. The Connection Responses comprise the nature of expected adaptations of Delay-Springs and Load-Springs of the multihop chains.

In a Net-Spring comparison step (730), MN (635) performs comparative operations on the Delay-Spring and Load-Spring values received from WCE (615) and WCE (625). In the step (730), MN (635) compares the expected delay and load performance encountered when exchanging communications in any of CN (610) and CN (620).

Then in a network selection step (735), MN (635) selects the preferred communications network to exchange communications with NC (605). In one aspect of the embodiment, network selection step (735) is used to select a preferred multihop chain to join.

After network selection step (735), MN (635) performs an Association Request step (520) in accordance with operations sequence (500). MN (635) performs subsequent steps of operations sequence (500) with the selected communications network.

This embodiment is illustrative of the advantages of the Net-Spring method in network selection among a plurality of communications networks. The method provides information on delay and load performance for a mobile node exchanging communications in an available plurality of communications networks. The Net-Spring method requires substantially fewer exchanges between a mobile node and available communications networks. As a result, the method requires substantially shorter delay in establishing communications.

### Embodiment 6

### QOS Management Application)

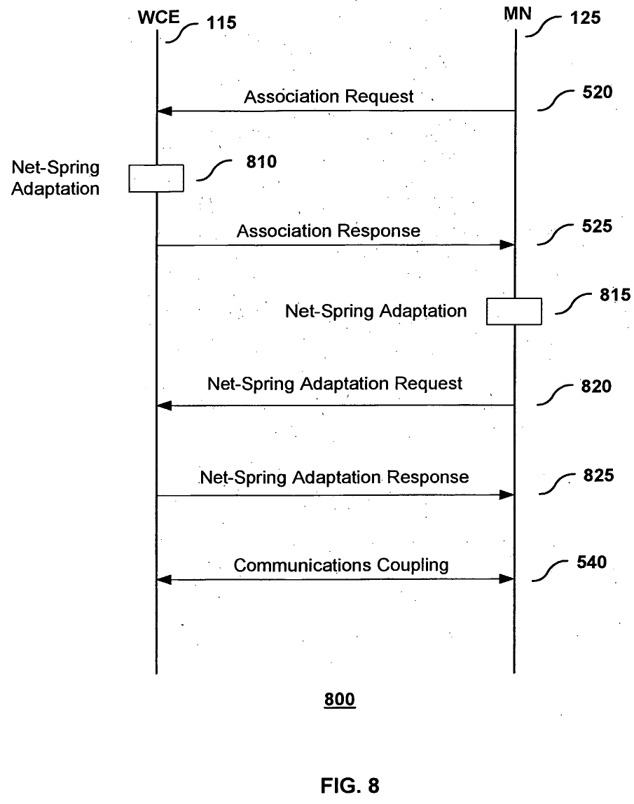

This embodiment illustrates an application of the Net-Spring method for quality of service (QoS) management. QoS performance is critical for communications networks. The ability to achieve desired QoS performance from commencement of communications is highly valued. The Net-Spring method for achieving such performance is presented with reference to communications network CN (100) of FIG. 1 and operation sequence (800) of FIG. 8.

In FIG. 1, MN (125) is initially seeking to establish communications coupling with CN (100). The Association Request of step (520) comprises information regarding QoS performance requirements of MN (125). In particular, this information comprises required delay conditions, offered traffic and delay-jitter requirements.

Then in a Net-Spring adaptation step (810), Delay-Spring of multihop chain MH (130) adapts in response to communications characteristics of MN (125). In an exemplification, Delay-Spring adapts by means of expansion to indicate higher delays due to increased communications exchanged in multihop chain MH (130). In another exemplification, Load-Spring adapts by means of expansion to indicate heavier traffic loads due to increased communications exchanged in MH (130).

In an Association Response step (525), WCE (115) of MH (130) notifies results of the Association Request of step (520) to MN (125). The Association Response comprises the values of expanded Delay-Spring and Load-Spring.

Based on the notified value of the Delay-Spring and Load-Spring of MH (130), MN (125) performs a Net-Spring Adaptation step (815). The step (815) comprises adaptations to operations of MN (125).

In one aspect of the invention, MN (12.5) adapts to expanded Load-Spring of multihop chain MH (130). An expanded Load-Spring indicates heavier communications traffic between end-nodes WCE (115) and NC (105). In one aspect, this translates in to heavier buffering in intermediate network devices, which in turn increases loss rates. Higher loss rates adversely affect communications throughput. Higher loss rates also require retransmissions, which increase communications delay. In accordance with the present invention, MN (125) adapts and reduces the effects of the expanded Load-Spring by decreasing communications traffic load. Such adaptation reduces communications traffic load between end-nodes WCE (115) and NC (105). This in turn reduces loss rates and decreases retransmissions. The effects of Net-Spring adaptation comprise enhanced communications throughput and reduced communications delay. The adapted operations are effective for duration of time as established by MN (125).

In another aspect of the invention, MN (125) adapts to expand Delay-Spring of multihop chain MH (130). An expanded Delay-Spring indicates longer communications delay between end-nodes WCE (115) and NC (105). In one aspect, this increased latency translates to decreased communications interactivity. In accordance with the present invention, MN (125) adapts and requests WCE (115) for higher communications priority. Such adaptation increases communications resources for MN (125). This in turn reduces communications delays and enhances interactivity. In a step (820) MN (125) sends a Net-Spring Adaptation Request to WCE (115) of MH (130). In response, WCE (115) adjusts communications priority subject to other network conditions. WCE (115) then sends a Net-Spring adaptation response in a step (825) with notification of adapted communications priority.

This embodiment illustrates the advantages of the Net-Spring method in QoS management of communications networks. The method provides information on delay and load performance for a mobile node exchanging communications in a communications network. The Net-Spring method requires substantially fewer exchanges between a mobile node and communications network. As a result, the method requires substantially shorter delay in establishing communications. The Net-Spring method provides network conditions of the entirety of multihop chain in a constrained set of parameters.

### Embodiment 7

### Block Diagram

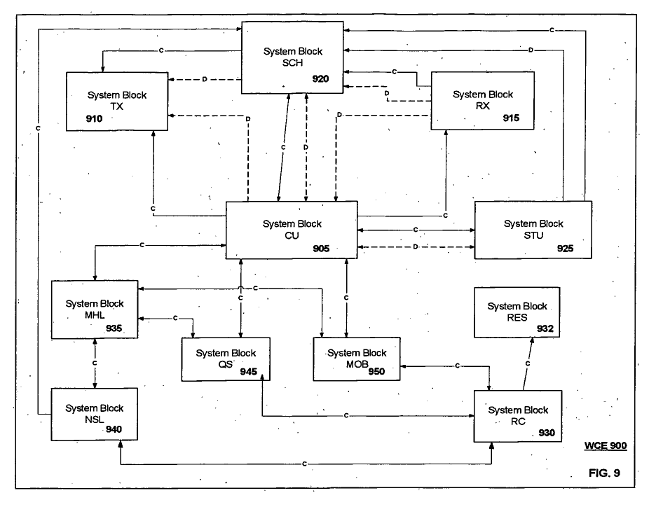

FIG. 9 illustrates an apparatus of a wireless communications entity WCE (900) that embodies the present invention for Net-Spring mobility management.

Wireless communications entity WCE (900) comprises a number of system blocks such as the Transmission system block (TX) (910) and Reception system block (915), which exchange data and control information with communications network entities such as multihop chain WCEs, network controller NC and other communications networks. Communications frames are exchanged between system blocks on paths corresponding to they type of frames. Consequently, there are two types of paths that are marked with ‘D’ and ‘C’, to denote exchange of data and control communications frames, respectively. TX (910) and RX (915) may operate based on a single or plurality of communications standards such as IEEE 802.11, Ethernet, IEEE 802.16, UWB, GPRS, Bluetooth, WCDMA and CDMA2000. All communications frames received by RX (915), comprising data and control frames, are appropriately forwarded to other system blocks such as Controlling Unit (CU) (905) and Scheduler (SCH) (920).

CU (905) is the main management system block. It performs computations and processing necessary for the overall control of the wireless communications entity. CU (905) manages the overall interaction of all system blocks of the WCE (900). CU (905) is representative of a main processing unit for the network device.

CU (905) and other system blocks of WCE (900) interact with the Storage Unit (STU) (925) for maintaining and retrieving information on parameters, processing buffers, communications frames, etc. The Storage Unit STU (925) comprises buffer or memory modules to store data and control information. STU (925) interfaces with CU (905) and SCH (920) over ‘D’ and ‘C’ paths.

Resource Controller (RC) (930) is responsible for effecting changes in parameters, operations of a single or plurality of resources of WCE (900). This comprises adjusting the transmission and reception schedules, adapting communication priorities, adjusting admission control parameters, etc. RC (930) also adjusts bandwidth reservations. Resources system block (RES) (932) is representative of resources of WCE (900).

The main system blocks of the present invention comprise Multihop Chain Logic system block (MHL) (935) and Net-Spring Logic system block (NSL) (940). MHL (935) configures and monitors multihop chains of which WCE (900) is constituent. In a first aspect, MHL (935) maintains the multihop chain identifiers of the multihop chains of WCE (900). For each multihop chain MHL (935) also maintains the hop count of WCE (900) from corresponding network controller of the multihop chain. In an example from CN (100) of FIG. 1, MHL (935) of WCE (115) of MH (130) maintains the multihop chain identifier of MH (130) and hop count “2” corresponding to the hop distance from NC (105).

NSL (940) maintains and adjusts Net-Springs of multihop chains of which WCE (900) is constituent. NSL (940) adapts Net-Springs to changes in network conditions. In one aspect, NSL (940) adapts Hop-Springs, Delay-Springs and Load-Springs of multihop chains of WCE (900).

NSL (940) and MHL (935) are interfaced over ‘C’ paths. NSL (940) signals MHL (935) on adaptations in Net-Springs due to changes in network conditions. In turn, MHL (935) adapts multihop chains in response to changes in their Net-Springs.

NSL (940) also interfaces with Scheduler SCH (920) over the ‘C’ path to exchange control information. In the event of changes in Net-Springs such as Delay-Spring of a multihop chain, NSL (940) communicates with SCH (920) to adjust communications priority for exchanging communications in a corresponding multihop chain. SCH (920) in turn adapts its transmission and reception schedules in accordance with changes in the Net-Springs. Operations of TX (910) and RX (915) are adapted based on changes in SCH (920).

NSL (940) also interfaces with Resource Controller RC (930) to affect changes for QoS management. For example, in an event of contraction of a Load-Spring of a multihop chain—indication of reduced load in the multihop chain—WCE (900) may admit greater communications session through the multihop chain. NSL (940) consequently notifies Resource Controller RC (930) to instruct admissions controller resource to increase admission of communications sessions. RC (930) in turn interfaces with the admissions controller in RES (932) to effect said adaptations.

Other system blocks of the present invention comprise the QoS Reservation block (QS) (945) and Mobility (MOB) block (950). QoS Reservation QS (945) is responsible for controlling Net-Spring adaptations relating to QoS performance. QS (945) interfaces Resource Controller RC (930), Controlling Unit CU (905) and MH-Chain Logic MHL (935) over ‘C’ paths. In one aspect of the invention, QS (945) exchanges signals with Resource Controller RC (930) for Hop-Spring, Delay-Spring and Load-Spring adaptations, said signals comprising signals for resource allocations and signals for priority settings. QS (945) receives information regarding Net-Springs and multihop chains for which QoS adaptations are to be made from CU (905 and MHL (935), respectively. QS (945) also comprises a clock mechanism for synchronization with CU (905) and Resource Controller RC (930).

Mobility MOB (950) is responsible for coordinating Net-Spring adaptations relating to mobility and handovers. MOB (945) interfaces Resource Controller RC (930), Controlling Unit CU (905) and MH-Chain Logic MHL (935) over ‘C’ paths. In one aspect of the invention, Mobility block MOB (950) exchanges location information Multihop-Chain Logic MHL (935), said location information comprising WCE attachment of a mobile node and mobile node resource requirements. MOB (950) also exchanges signals with Resource Controller RC (930) for Net-Spring adaptations. For example, in the case of a mobility event, MOB (950) exchanges signals relating to resource requirements for mobile node to maintain seamless communications performance.

In the case of network selection, RX (915) receives a Connection Request (710) from a mobile node providing information on required communications performance. The Connection Request (710) is then sent over ‘D’ path to Controlling Unit CU (905). CU (905) then reviews the information and provides control signals corresponding to the required communications performance to MHL (935). MHL (935) then matches the control signals to corresponding multihop chain. MHL (935) exchanges the control signals with Net-Spring Logic NSL (940). NSL (940) then determines, in a step (712), expected adaptations of a single of plurality of Delay-Springs or Load-Springs in response to the required communications performance of the mobile node. Based on these determinations, NSL (940) signals MHL (935), which in turn signals CU (905). CU (905) then prepares a Connection Response comprising expected values of Delay-Springs and Load-Springs resulting from adaptation to the mobile node. TX (910) transmits the Connection Response to the mobile node in a step (715).

In the case of QoS management, RX (915) receives an Association Request (520) from a mobile node providing information on required communications performance.

In the case of mobility, RX (915) receives an Association Request (520) from a mobile node providing information comprising identification of a multihop chain through which the mobile node conducted communications, previous Hop-Spring value of the multihop chain and previous neighbor of the mobile node.

The Association Request is then sent over a ‘D’ path to Controlling Unit (905). CU (905) then reviews the information and provides control signals corresponding to the identification information to MHL (935). MHL (935) then exchanges the control signals with Net-Spring Logic NSL (940). NSL (940) then determines a corresponding adaptation by means of contraction or expansion. This adaptation is signaled to CU (905) through MHL (935). CU (905) then exchanges corresponding Net-Spring Expansion Request and Responses with other WCEs through TX (910) and RX (915).

Then NSL (940) performs a Hop-Spring Adaptation step (537) to expand or contract the Hop-Spring. After the Hop-Spring Adaptation, NSL (940) signals MHL (935) of the nature of the adaptation. NSL (940) signals are exchanged with MHL (935) over a ‘C’ path. MHL (935) then adapts the multihop chain corresponding to the Hop-Spring in a step (539). In the step (539), MHL (935) adapts to expand a multihop chain by including a new WCE or adapts to exclude a multihop chain by excluding an existing WCE.

After the multihop chain has been adapted, MHL (935) signals the controlling unit CU (905) of the change in Hop-Spring. CU (905) then constructs an Association Response and sends it to the mobile node in a step (525). The Association Response comprises information for the mobile node to establish communications coupling with the WCE and commence communications.

This embodiment illustrates the system blocks of the invention, in particular the system blocks Multihop Chain Logic MHL (935) and Net-Spring Logic NSL (940). The system blocks of the invention for Net-Spring may be realized in an integrated circuit. They may also constitute a singular or plurality of modules on a system-on-chip.

### Embodiment 8

### Message Format

The operations of the disclose invention may be realized by means of a set of Net-Spring control messages. Net-Spring control messages are exchanged among mobile nodes, multihop chain WCEs and network controller.

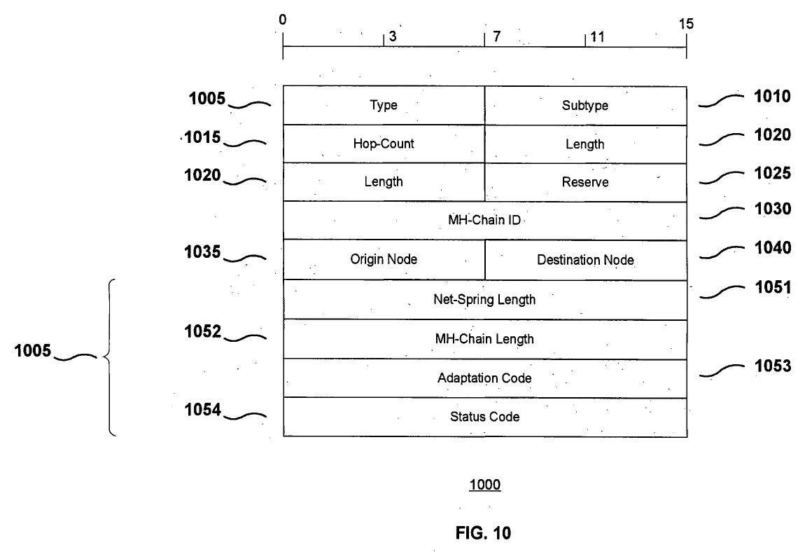

The message format (1000) for exchanging Net-Spring control messages among communications entities of a multihop chain is illustrated in FIG. 10. Net-Spring control messages may be transported over protocols such as IP, TCP, UDP, IETF CAPWAP, IEEE 802.11, IEEE 802.16, Bluetooth, Selective Distribution of Infrastructure (SDI) protocol, GPRS, WCDMA and CDMA2000. The message format (1000) indicates 8-byes header followed by a single or plurality of Net-Spring attributes.

The 1-byte Type field (1005) denotes the type of Net-Spring message that is exchanged. It is assigned a value currently unassigned by the Internet Assigned Numbers Authority (IANA). The value of the Type field (1005) may signify any one of Net-Spring messages, such as messages for Net-Spring adaptation request or response; messages for Net-Spring adaptation results; and messages for multihop chain adaptation triggers or response. In particular, the values of the Type field (1005) comprise those corresponding to Net-Spring Adaptation Request or Response, Net-Spring Expansion Request or Response and Net-Spring Contraction Request or Response.

The next 1-byte Sub-Type field (1010) signifies the nature of the Net-Spring relating to the message. The Sub-Type field (1010) identifies Net-Springs such as Hop-Spring, Load-Spring and Delay-Spring. The values of the field as assigned in accordance with the type of Net-Spring. The values may be assigned by the IANA.

The next 1-byte Hop-Count field (1015) signifies the number of hops the Net-Spring control message has made so far across the multihop chain from the message originator. The value of this field is incremented by one by each recipient of the Net-Spring control message other than the intended final recipient. This field is used to track path loops or other adverse conditions. In one case, it can be determined if there are loops in the multihop chain from the value of the Hop-Count field (1015) in comparison to the total count of WCEs in the multihop chain.

The 2-bytes Length field (1020) denotes the total length of the Net-Spring control message inclusive of Net-Spring attributes and payload.

The following 1-byte Reserve field (1025) is used for exchanging additional information and for future updates to the Net-Spring method.

The MH-Chain ID field (1030) is a 2-bytes field identifying the multihop chain for which the Net-Spring control message is applicable. In one aspect of the invention, MH-Chain ID (1030) is assigned a value based on the MAC address of the network controller interface used for communications with a multihop chain. In another aspect, MH-Chain ID (1030) is assigned a unique value by NC during the initial exchanges with a WCE.

The Origin Node field (1035) signifies the identity of the mobile node, WCE or NC initiating the Net-Spring control message. In one aspect of the invention, each mobile node, WCE or NC in a multihop chain is assigned numeric identities. For instance, NC is assigned identity of ‘0’ and each subsequent downstream WCE and mobile node in the multihop chain is assigned identities of incrementally ascending values, such as ‘1’, ‘2’, ‘3’ etc. In another aspect of the invention, each mobile node, WCE or NC in a multihop chain is assigned identities based on their respective Medium Access Control (MAC) addresses. In accordance with the invention of Net-Spring, the multihop chain identified by MH-Chain ID field (1030) may or may not comprise the communications entity identified by the Origin Node field (1035).

The Destination Node field (1040) signifies the identity of the mobile node, WCE or NC that is the recipient of the Net-Spring control message. This field is distinct from the Hop-Count field (1015), which is indicative of the mobile node, WCE or NC currently receiving the Net-Spring control message. In one aspect of the invention, the multihop chain entity at which the values of Hop-Count field (1015) and Destination Node field (1040) match denotes the entity at which the Net-Spring control message is ultimately processed. A special Destination Node field (1040) value is used to indicate all mobile nodes and WCEs comprising the multihop chain. This value is used to distribute broadcast messages that all mobile nodes and WCEs of the multihop chain require.

The subsequent attribute fields (1050) after Destination Node field (1040) contain attributes related to various operations of the Net-Spring method. A Net-Spring Length attribute (1051) comprises the value of the length of the particular Net-Spring. The field may comprise values comprising the path length of a Hop-Spring, the delay duration of a Delay-Spring and communications traffic level of a Load-Spring.

A MH-Chain Length attribute (1052) signifies the value of the prevailing length of the multihop hop specified by the value of the MH-Chain ID field (1030). The value may be specified in terms comprising hops, delay and load.

The next Adaptation Code attribute (1053) indicates the type of adaptation to be performed for a Net-Spring or multihop chain. In one aspect, a value “0” for the Adaptation Code attribute (1053) specifies contraction of a Net-Spring or multihop chain and a value “1” specifies expansion of a Net-Spring or multihop chain. The Adaptation Code attribute (1053) is used in a set of messages comprising Net-Spring Adaptation Request, Net-Spring Expansion Request and Net-Spring Contraction Request.

A Status Code attribute (1054) specifies the result of a Net-Spring operational step. In one aspect, the value of this attribute may indicate “0” for operation failure and “1” for operation success.

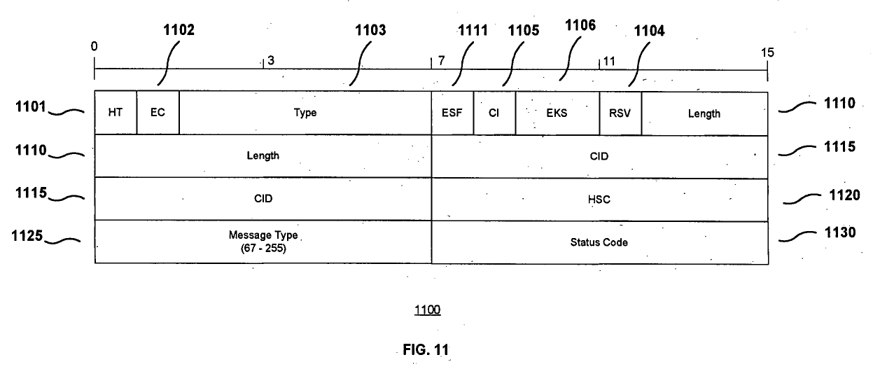

Message format (1100) of FIG. 11 is illustrative of Net-Spring control messages in accordance with the IEEE 802.11 MAC PDU format. The Header Type (HT) field (1101) denotes a general IEEE 802.16 MAC header for exchanging MAC management messages. The value of this field is set to “0” for Net-Spring control messages.

The 1-bit Encryption Control (EC) field (1102) is set to a value “0” to indicate the payload is not encrypted. In one aspect of the invention, Net-Spring payload and attributes are not encrypted as they may be exchanged before security establishment. The 2-bits Encryption Key Sequence (EKS) field (1106) is accordingly unused.

The next Type field (1103) signifies the general type of the message.

The CRC Indicator (CI) field (1105) denotes the presence of a CRC in the PDU. In one aspect of the invention, CRC is included and CI (1105) is assigned a value “1”.

Reserve (RSV) field (1104) is used for other or future applications.

The 11-bits Length field (1110) signifies the length of the MAC PDU in bytes. The length comprises MAC header and CRC.

The subsequent 16-bits Connection Identifier (CID) field (1115) identifies the logical connection used between the MAC modules of communicating entities. This is followed by an 8-bits Header Check Sequence (HCS) field (1120) The value present in this field is used to detect errors in the IEEE 802.11 MAC PDU header.

The IEEE 802.11 MAC management message type field (1125) comprises value corresponding to the Type field (1005) of message format (1000). The field identifies the type of MAC management message dealing with Net-Spring control messages. The subsequent field (1130) comprises the remaining sub-header and fields of message format (1000). The Extended Subheader field (ESF) (1111) is set to a value “1” in accordance with the IEEE 802.16 communications standard to indicate the presence of an extended subheader. The ESF (1111) signifies the presence of a subheader corresponding to Net-Spring operations.

This embodiment highlights the message format for the Net-Spring control messages operating in accordance with the invention for adapting multihop chains in accordance with corresponding Net-Springs. The message format structures are exchanged among mobile nodes, WCEs and NC so that mobility, QoS management and network selection are efficiently achieved.

Net-Spring message exchanges are secured between the Origin Node and Destination Node. Intermediate mobile nodes and WCEs do not have access to change the payload of Net-Spring messages that they are not ultimately responsible for.

### Embodiment 9

### Flowchart

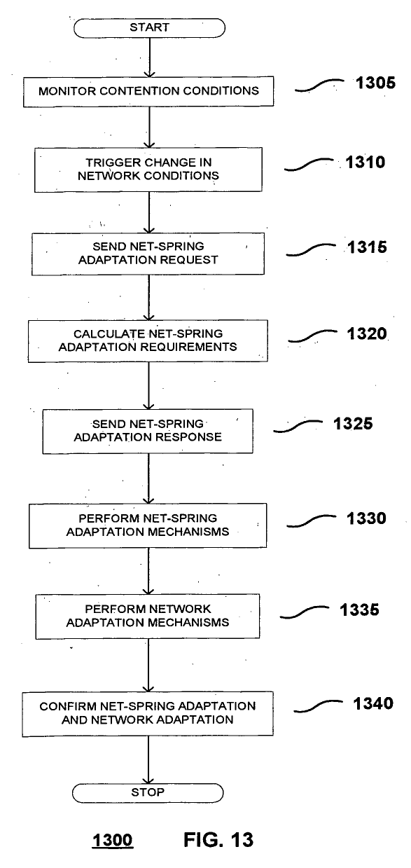

Flowchart (1300) of FIG. 13 illustrates steps performed by network entities, such as wireless communications entities (WCE), network controllers (NC) and mobile nodes (MN), for operations in accordance with the present invention for Network-Springs and their adaptation in response to network conditions.

In a first step (1005), a network entity monitors networks conditions of the communications network. The step (1005) comprises monitoring mobility events, the network distance between end-nodes, delay between end-nodes and communications traffic load between end-nodes. In one aspect of the invention, network distance is the number of hops between end-nodes. In one aspect of the invention, delay between end-nodes is determined as the round-trip delay. In an exemplification, a first end-node sends a communications message to a second end-node and begins a timer. Upon receiving the communications message, the second end-node sends a communications message to the first end-node. The time difference between sending of a first communications message and receipt of a second communications message is indicative of delay between the end-nodes. In one aspect of the invention, communications traffic load between end-nodes is determined by means of regular control message exchanged between the end-nodes.

A step (1310) occurs upon changes in network conditions monitored in the step (1305). The step (1310) comprises send a single or plurality of Trigger Requests. The Trigger Request is a set of general messages comprising Association Requests and Connection Requests.

In a next step (1315), the network entity sends a Net-Spring Adaptation Request. This step comprises identifying the Net-Spring affected by change in network conditions. The step (1315) also comprises sending information regarding the degree of change in network conditions and further information regarding said change.

Net-Spring adaptation is then calculated in a step (1320). This comprises determination of the extent of network changes and the adaptation required to accommodate said network changes. In one aspect of the invention, the step (1320) comprises calculation of the degree of expansion or contraction for a single or plurality of Net-Springs. In another aspect of the invention, the step comprises calculations to determine if any adaptation is required for a single or plurality of Net-Springs. The outcome of this calculation is a no-change response. The result of the Net-Spring adaptation step (1320) is sent to the network entity initiating the operations in a step (1325).

The initiating network entity then performs Net-Spring adaptation in a step (1330) in accordance with the response of (1325). The Net-Spring adaptation step (1330) comprises adaptations of a single or plurality of Hop-Spring, Delay-Spring and Load-Spring. The adaptations may be expansion, contraction or no-change in said Net-Springs. In one aspect of the invention, the adaptation step (1330) comprises diverging adaptations for Net-Springs. For example, during a step (1330), a first Hop-Spring may be expanded, while a second Delay-Spring may be contracted. In another example, a first Delay-Spring may be expanded while a second Delay-Spring may be contracted. In accordance with the present invention, the adaptation step (1330) may be performed independently for a Net-Spring or may be synthesized among a plurality of Net-Springs.

In a next step (1335), network adaptation is performed. The step is performed when adaptation of Net-Springs results in adaptation requirements in network elements, such as multihop chains. In one aspect of the invention, adaptation of Hop-Spring requires adaptation in corresponding multihop chain. So expansion of a Hop-Spring results in expansion of corresponding multihop chain in the step (1335).

In a next step (1340), confirmation of the Net-Spring adaptation and network adaptation operations are performed. The step comprises sending a single or plurality of Trigger Response messages to the initiator of the adaptation operations.

This embodiment of functional flows of the current invention highlights the operative steps. It illustrates the relative steps performed by a network entity operating in accordance with the invention for Network Springs and their adaptation in response to network conditions.

### Embodiment 10

### Intermediate Net-Springs

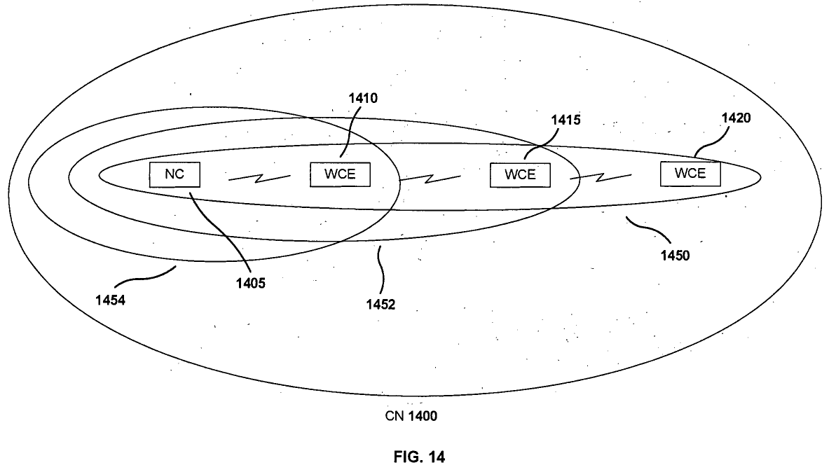

This embodiment illustrates the present invention as operational with a plurality of intermediate Network Springs. CN (1400) of FIG. 14 comprises a Network Controller NC (1405) and Wireless Communications Entities WCE (1410), (1415) and (1415). Each of the WCEs maintains a single or plurality of Net-Springs with end-node NC (1405).

FIG. 14 is illustrative of Net-Spring (1450) between end-nodes WCE (1420) and NC (1405), Net-Spring (1452) between WCE (1415) and NC (1405) and Net-Spring (1454) between WCE (1410) and NC (1405). The Net-Springs may be of distinct variants such as Hop-Spring, Delay-Spring or Load-Spring. In an exemplification, Net-Springs (1450), (1452) and (1454) are representative of delay conditions between their respective end-nodes.

The plurality of Net-Springs of CN (1400) is adapted in accordance with the present invention, individually or in synthesis. The Net-Springs of CN (1400) may have different values and may be adapted distinctly in response to network conditions. This is representative of the varying network conditions between different sets of end-nodes. For example, Net-Spring (1450) may represent a Delay-Spring of value 30 ms between end-nodes WCE (1420) and NC (1405), whereas Net-Spring (1452) may represent a Delay-Spring of value 50 ms between end-nodes WCE (1415) and NC (1405). This may be due to increased processing delays at WCE (1415) for communications traffic originating from WCE (1415), whereas processing delays are minimal for forwarding communications traffic from WCE (1420). This illustrates the diverging nature of Net-Springs at different reference points of a communications network.

In another example, Net-Springs of CN (1400) may be cumulative in their effects. In the case of Net-Springs (1450), (1452) and (1454) representative of Hop-Springs, each Net-Spring with end-node away from NC (1405) will have larger Hop-Spring value. For instance, Net-Spring (1454) between WCE (1410) and NC (1405) has a Hop-Spring value of “0” to indicate next hop communications. For Net-Spring of subsequent WCE (1415), Net-Spring (1452) has a Hop-Spring value of “1” to indicate communications with NC (1405) over “1” intermediate hop. This is illustrative of the cumulative effects of Net-Springs over a set of intermediate network entities of a communications network.

This embodiment highlights the diversity of Network Springs a communications, network. Intermediate Net-Springs may comprise distinct or diverging values, which may be adapted in accordance with the present invention. The advantage illustrated in this embodiment is the flexibility of adapting Net-Springs in response to network conditions at different reference points of a communications network. This in turn enhances mobility and QoS performance across the communications network.

The aforementioned embodiments of the invention illustrate the applications of the invention for Network-Springs and their adaptations in response to network conditions. The embodiments show how, the invention helps to reduce handover time and enhance mobility and QoS performance.

1-7. (canceled)

8. A method of managing network conditions in a multihop communications network, comprising the step of:
representing a single or plurality of network conditions; and
assigning said representations to a set of communications entities comprising the multihop communications network,
wherein said representing are adapted in response to mobility events within the multihop communications network.

9. A method of managing according to claim 8, wherein said representing are adapted by steps comprising;
adapting a traffic load over a set of communications entities;
adapting a priority of network traffic over a set of communications entities;
adapting the number of communications entities within a set of communications entities; and
adapting a communications delay over a set of communications entities.
